(19) United States
(12) Patent Application Publication
(10) Pub. No.: US 2022/0301326 A1
(43) Pub. Date: Sep. 22, 2022

(54) OCR TARGET AREA POSITION ACQUISITION SYSTEM, COMPUTER-READABLE NON-TRANSITORY RECORDING MEDIUM STORING OCR TARGET AREA POSITION ACQUISITION PROGRAM, HARD COPY, HARD COPY GENERATION SYSTEM, AND COMPUTER-READABLE NON-TRANSITORY RECORDING MEDIUM STORING HARD COPY GENERATION PROGRAM

(71) Applicant: KYOCERA Document Solutions Inc., Osaka-shi (JP)

(72) Inventor: Hideyuki SASAKI, Osaka-shi (JP)

(21) Appl. No.: 17/691,243

(22) Filed: Mar. 10, 2022

(30) Foreign Application Priority Data
Mar. 19, 2021 (JP) 2021-045887

(51) Int. Cl. G06V 30/146; G06V 30/14; G06V 30/20

(52) U.S. Cl. CPC G06V 30/1463; G06V 30/1444; G06V 30/20

(57) ABSTRACT

An OCR system acquires the position of an image code in a document image, acquires data indicated by the image code, and acquires the position of a handwriting input field in the document image on the basis of the position of the image code in the acquired document image, the position of the image code in the document included in the acquired data, and the position of the handwriting input field in the document included in the acquired data.

### INCORPORATION BY REFERENCE

This application is based upon, and claims the benefit of priority from, corresponding Japanese Patent Application No. 2021-045887 filed in the Japan Patent Office on Mar. 19, 2021, the entire contents of which are incorporated herein by reference.

### BACKGROUND

### Field of the Invention

The disclosure relates to an optical character recognition (OCR) target area position acquisition system that acquires the position, in a document image, of an OCR target area that is an area subjected to OCR processing in a document image, which is an image of a document, a computer-readable non-transitory recording medium storing an OCR target area position acquisition program, a hard copy, a hard copy generation system, and a computer-readable non-transitory recording medium storing hard copy generation program.

### Description of Related Art

Typically, there are known techniques for performing OCR processing on OCR target areas in document images.

### SUMMARY

An OCR target area position acquisition system according to the disclosure includes an image code position acquiring unit that acquires a position of an image code in a document image, the document image being an image of a document to which data is added by the image code; a data acquiring unit that acquires the data indicated by the image code; and an ORC target area position acquiring unit that acquires a position of an OCR target area in the document image, the OCR target area being an area, in the document image, to be subjected to OCR processing. The data added to the document by the image code includes: image code position data including a position of the image code in the document; and OCR target area position data including a position of the OCR target area in the document. The ORC target area position acquiring unit acquires a position of the ORC target area in the document image based on a position of the image code in the document image, the image code being acquired by the image code position acquiring unit; a position of the image code in the document, the image code being included in the image code position data acquired by the data acquiring unit; and a position of the OCR target area in the document, the OCR target area being included in the OCR target area position data acquired by the data acquiring unit.

A computer-readable non-transitory storage medium according to the disclosure storing an OCR target area position acquisition program causes a computer to realize an image code position acquiring unit that acquires a position of an image code in a document image, the document image being an image of a document to which data is added by the image code; a data acquiring unit that acquires the data indicated by the image code; and an ORC target area position acquiring unit that acquires a position of an OCR target area in a document image, the OCR target area being an area, in the document image, to be subjected to OCR processing. The data added to the document by the image code includes: image code position data including a position of the image code in the document; and OCR target area position data including a position of the OCR target area in the document. The ORC target area position acquiring unit acquires a position of the ORC target area in the document image based on a position of the image code in the document image, the image code being acquired by the image code position acquiring unit; a position of the image code in the document, the image code being included in the image code position data acquired by the data acquiring unit; and a position of the OCR target area in the document, the OCR target area being included in the OCR target area position data acquired by the data acquiring unit.

A hard copy according to the disclosure is an actual document to which data is added by an image code. The data added to the document by the image code includes image code position data including a position of the image code in the document; and OCR target area position data including a position of an OCR target area in the document, the OCR target area being an area, in an image of the document, to be subjected to OCR processing.

A hard copy generation system according to the disclosure includes a hard copy generating unit that generates a hard copy, the hard copy being an actual document to which data is added by an image code. The data added to the document by the image code includes image code position data including a position of the image code in the document; and OCR target area position data including a position of an OCR target area in the document, the OCR target area being an area, in the image of the document, to be subjected to OCR processing.

A computer-readable non-transitory storage medium according to the disclosure storing a hard copy generation program that causes a computer to realize a hard copy generating unit that generates a hard copy, the hard copy being an actual document to which data is added by an image code. The data added to the document by the image code includes image code position data including a position of the image code in the document; and OCR target area position data including a position of an OCR target area in the document, the OCR target area being an area, in the image of the document, to be subjected to OCR processing.

### BRIEF DESCRIPTION OF THE DRAWINGS

FIG. 1 is a block diagram of a system according to an embodiment of the disclosure;

FIG. 2 is a block diagram of the OCR system illustrated in FIG. 1, in a case where configured by a single computer;

FIG. 3 is a block diagram of the MFP illustrated in FIG. 1;

FIG. 4 is a block diagram of the user terminal illustrated in FIG. 1;

FIG. 5 is a flowchart illustrating an operation of the OCR system illustrated in FIG. 2, when the MFP is made to print a document;

FIG. 6 is a diagram illustrating an example document created during the operation illustrated in FIG. 5;

FIG. 7 is a diagram illustrating the example document illustrated in FIG. 6 with image codes;

FIG. 8 is a diagram illustrating example data indicated by the image codes illustrated in FIG. 7;

FIG. 9 is a flowchart illustrating an operation of the OCR system illustrated in FIG. 2, in a case where information is extracted from a document image;

FIG. 10A is a diagram illustrating an example of a handwriting input field and an image code on a hard copy that is a target of the operation illustrated in FIG. 9; and

FIG. 10B is a diagram illustrating an example of a handwriting input field and an image code in a document image read from the hard copy illustrated in FIG. 10A.

### DETAILED DESCRIPTION

Embodiments of the disclosure will now be described with reference to the accompanying drawings.

The configuration of a system according to an embodiment of the disclosure will now be described.

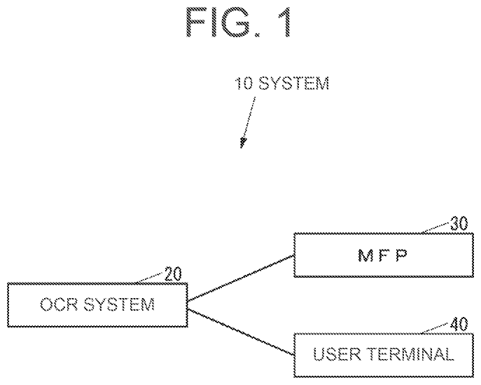

FIG. 1 is a block diagram illustrating a system 10 according to the present embodiment.

As illustrated in FIG. 1, the system 10 includes an optical character recognition (OCR) system 20, a multifunction peripheral (MFP) 30, and a user terminal 40. The OCR system 20 extracts information from a document image. The MFP 30 serves as an image reading apparatus that reads a document image from a hard copy composed of a recording medium, such as paper.

The OCR system 20 may include a single computer or a plurality of computers.

The OCR system 20 and the MFP 30 are capable of communicating with each other over a network, such as a local area network (LAN) and the Internet, or without any networks but directly through a wired or wireless connection. Similarly, the OCR system 20 and the user terminal 40 are capable of communicating with each other over a network, such as a LAN and the Internet, or without any networks but directly through a wired or wireless connection.

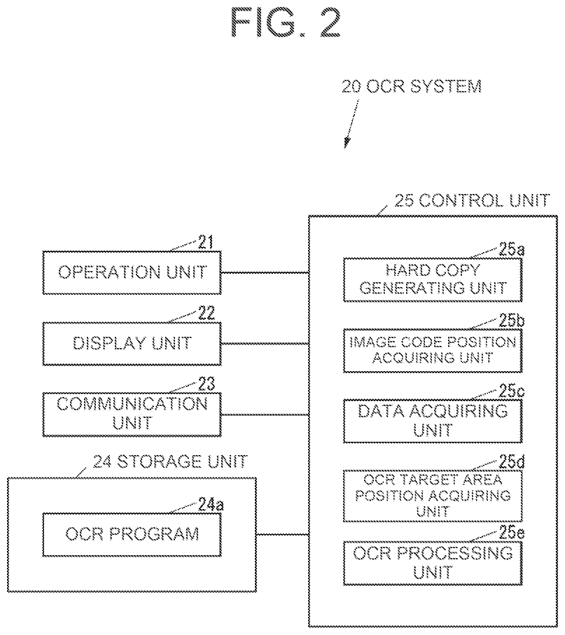

FIG. 2 is a block diagram illustrating the OCR system 20, in a case where the OCR system 20 is configured of a single computer.

The OCR system 20 illustrated in FIG. 2 includes an operation unit 21, a display unit 22, a communication unit 23, a storage unit 24, and a control unit 25. The operation unit 21 is an operation device, such as a keyboard or a mouse, with which various operations are input. The display unit 22 is a displaying device, such as a liquid crystal display (LCD), for displaying various kinds of information. The communication unit 23 is a communication device for communicating with external devices over a network, such as a LAN and the Internet, or without any networks but directly through a wired or wireless connection. The storage unit 24 is a non-volatile storage device, such as a semiconductor memory or a hard disk drive (HDD), for storing various kinds of information. The control unit 25 comprehensively controls the OCR system 20.

The storage unit 24 stores an OCR program 24a for executing OCR processing. The OCR program 24a, for example, may be installed in the OCR system 20 at a manufacturing stage of the OCR system 20, may be additionally installed in the OCR system 20 from an external storage medium, such as a universal serial bus (USB) memory, or may be additionally installed in the OCR system 20 from the network.

The control unit 25 includes, for example, a central processing unit (CPU), a read-only memory (ROM) storing programs and various kinds of data, and a random access memory (RAM) that is a memory used as a work area for the CPU of the control unit 25. The CPU of the control unit 25 executes a program stored in the storage unit 24 or the ROM of the control unit 25.

The control unit 25 executes the OCR program 24a to implement a hard copy generating unit 25a that generates a hard copy to which data is added by image codes, such as one-dimensional or two-dimensional codes. Thus, the OCR system 20 and the OCR program 24a constitute a hard copy generation system and a hard copy generation program of the disclosure, respectively.

The control unit 25 executes the OCR program 24a to implement an image code position acquiring unit 25b, a data acquiring unit 25c, and an OCR target area position acquiring unit 25d. The image code position acquiring unit 25b acquires the positions of the image codes in a document image. The data acquiring unit 25c acquires the data indicated by the image cades. The OCR target area position acquiring unit 25d acquires the position, in the document image, of a handwriting input field, which is an OCR target area subjected to OCR processing in the document image. Thus, the OCR system 20 and the OCR program 24a constitute an OCR target area position acquisition system and an OCR target area position acquisition program of the disclosure, respectively.

The control unit 25 executes the OCR program 24a to implement an OCR processing unit 25e that extracts information from the handwriting input field in the document image through OCR processing.

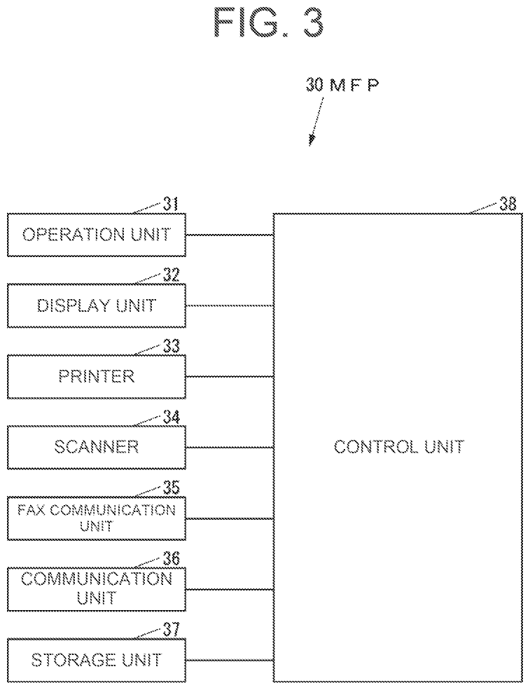

FIG. 3 is a block diagram of the MFP 30.

The MFP 30 as illustrated in FIG. 3 includes an operation unit 31, a display unit 32, a printer 33, a scanner 34, a display unit 32, a fax communication unit 35, a communication unit 36, a storage unit 37, and a control unit 38. The operation unit 31 is an operation device, such as buttons, with which various operations are input. The display unit 32 is a display device, such as an LCD, for displaying various kinds of information. The printer 33 is a printing device for printing an image on a recording medium, such as a sheet of paper. The scanner 34 is a reading device for reading an image from a document. The fax communication unit 35 is a faxing device that performs facsimile communications with external fax machines (not illustrated) through a communications line, such as a public telephone line. The communication unit 36 is a communication device for communicating with external apparatuses over a network, such as a LAN and the Internet, or without any networks but directly through a wired or wireless connection. The storage unit 37 is a non-volatile storage device, such as a semiconductor memory or an HDD, for storing various kinds of information. The control unit 38 comprehensively controls the MFP 30.

The control unit 38 includes, for example, a CPU, a ROM storing programs and various kinds of data, and a RAM serving as a memory used as a work area of the CPU of the control unit 38. The CPU of the control unit 38 executes the programs stored in the storage unit 37 or the ROM of the control unit 38.

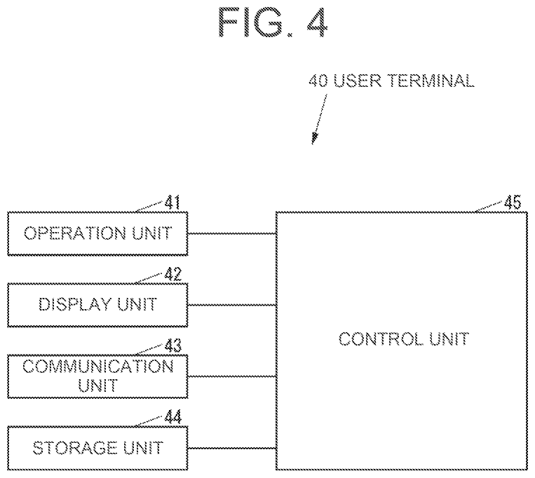

FIG. 4 is a block diagram of the user terminal 40.

The user terminal 40 illustrated in FIG. 4 includes an operation unit 41, a display unit 42, a communication unit 43, a storage unit 44, and a control unit 45. The operation unit is an operation device, such as a keyboard or a mouse, with which various operations are input. The display unit 32 is a display device, such as an LCD, for displaying various kinds of information. The communication unit 43 is a communication device that communicates with external devices via a network, such as a LAN and the Internet, or without any networks but directly through a wired or wireless connection. The storage unit 44 is a non-volatile storage device, such as a semiconductor memory or an HDD, for storing various kinds of information. The control unit 45 comprehensively controls the user terminal 40. The user terminal 40 includes, for example, a personal computer (PC).

The control unit 45 includes, for example, a CPU, a ROM storing programs and various kinds of data, and a RAM serving as a memory used as a work area of the CPU of the control unit 45. The CPU of the control unit 45 executes the programs stored in the storage unit 44 or the ROM of the control unit 45.

The operation of the system 10 will now be explained.

The operation of the OCR system 20 when the MFP 30 is made to print a document will now be explained.

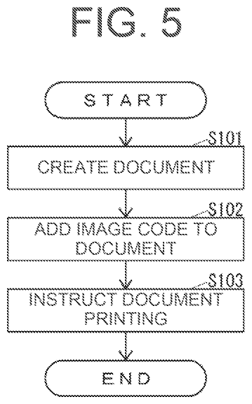

FIG. 5 is a flowchart illustrating the operation of the OCR system 20 when the MFP 30 is made to print a document.

A user (hereinafter, referred to as “operator”) of the OCR system 20 can instruct the OCR system 20 to create a document through the operation unit 41 of the user terminal 40. Thus, as illustrated in FIG. 5, the hard copy generating unit 25a of the OCR system 20 creates a document in accordance with an instruction from the operator (step S101).

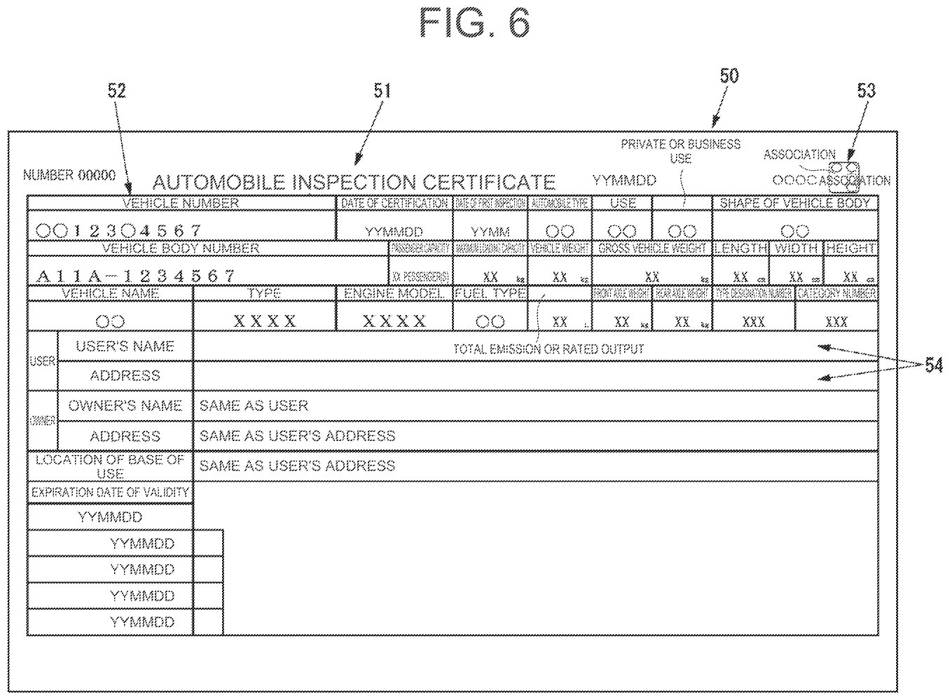

FIG. 6 is a diagram illustrating an example document 50 created in step S101.

The document 50 illustrated in FIG. 6 includes various text 51, various guidelines 52, various images 53, and fields 54 for inputting handwritten characters (hereinafter referred to as “handwriting input fields”).

After the OCR system 20 has been instructed to create a document, the operator can instruct the OCR system 20 to add data to the document by image codes through the operation unit 41 of the user terminal 40. Thus, after step S101, the hard copy generating unit 25a of the OCR system 20 adds image codes corresponding to the data in accordance with the instructions from the operator to the document created in step S101, as illustrated in FIG. 5 (step S102). Here, the image codes can be, for example, QR codes (registered trademark). In the following, the image codes are assumed to be QR codes.

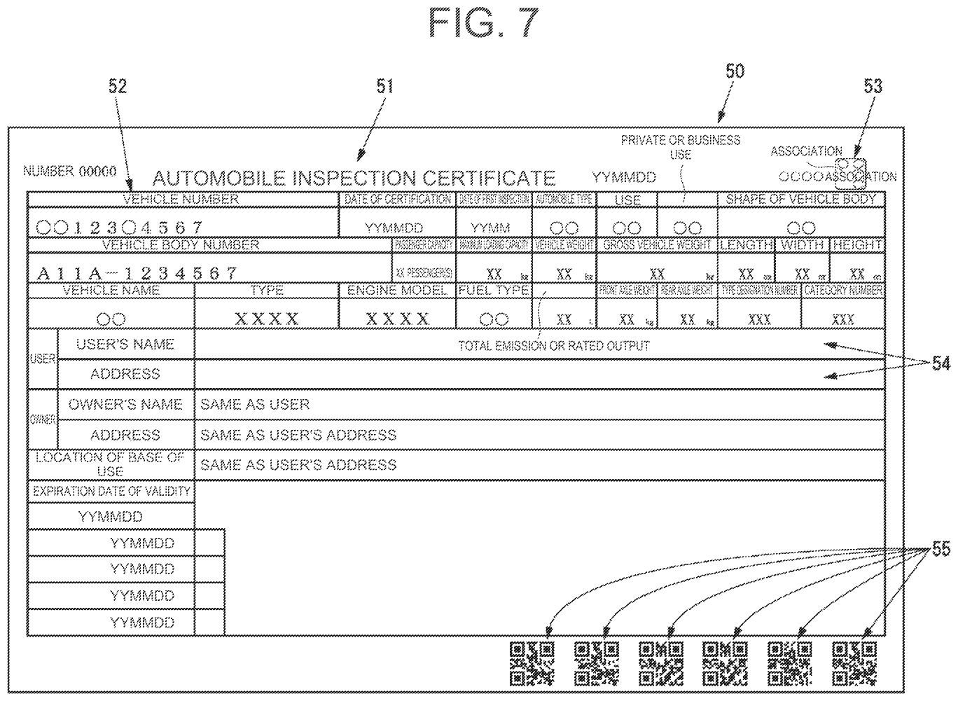

FIG. 7 is a diagram illustrating an example of the document 50 to which image codes 55 are added in step S102.

As illustrated in FIG. 7, multiple image codes 55 may be added to the document 50 depending on the size of the data in accordance with the instructions from the operator.

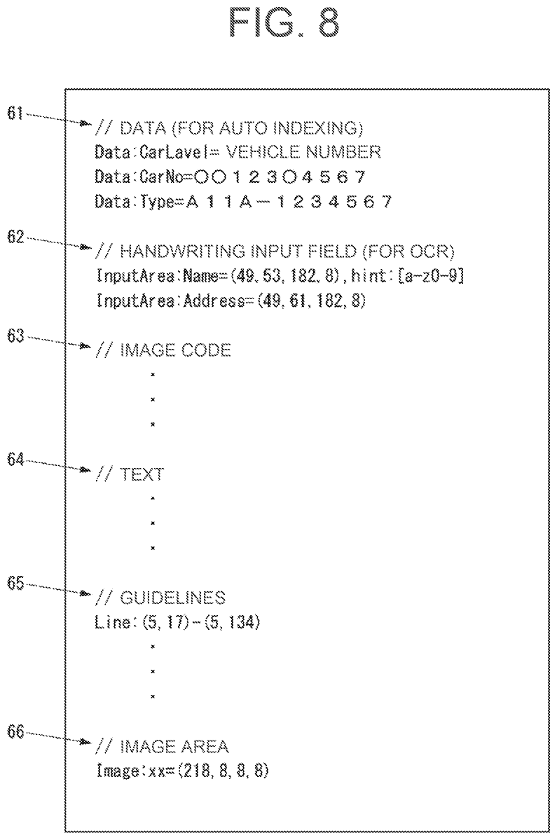

FIG. 8 is a diagram illustrating example data indicated by the image codes 55. Some of the data in FIG. 8 is illustrated in abbreviated forms.

As illustrated in FIG. 8, the data added to the document by the image codes in step S102 includes: data (hereinafter referred to as “auto-indexing data”) 61 for determining the destination of the information extracted through the OCR processing and for aggregating various kinds of information; data (hereinafter referred to as “handwriting input field data”) 62 pertaining to the handwriting input fields 54; data (hereinafter referred to as “image code position data”) 63 indicating the positions of the image codes 55 in the document 50; data (hereinafter referred to as “text data”) 64 for the reproduction of the text 51; data (hereinafter referred to as “guideline data”) 65 for the reproduction of the guidelines 52; and data (hereinafter referred to as “image data”) 66 for the reproduction of the image 53.

The auto-indexing data 61 may include, for example, identification information and a value for each piece of data. The value of the auto-indexing data 61 may be, for example, any piece of text 51. For example, “Data:CarLavel=Vehicle Number” indicates that the data value of the identification information “CarLavel” is “Vehicle Number.”

The handwriting input field data 62 may include, for example, identification information and the position and size in the document 50 for each handwriting input field. The handwriting input field data 62 includes the position of the handwriting input field as the OCR target area in the document 50, and constitutes the OCR target area position data of the disclosure. For some handwriting input fields, the type of characters used may be included in the handwriting input field data 62. For example, “InputArea:Name=(49,53,182,8), hint:[a-z0-9]” indicates that the position, in document 50, of the upper left corner of the handwriting input field of which the identification information is “Name” is 49 steps to the right and 53 steps down from the upper left corner of document 50, that the size of the text input field is 182 in the left-right direction and 8 in the top-bottom direction, and that the type of characters used in the text input field is only lowercase letters and numbers.

The image code position data 63 may include, for example, the position, in the document 50, of the upper left corner, the upper right corner, and the lower left corner of the corresponding image code 55. Note that the image code position data 63 may be data indicating only the position of a specific image code 55, such as the position of the leftmost image code 55, when multiple image codes 55 are added to the document 50.

The text data 64 may include the position of each text in the document 50.

The guideline data 65 may include the position of each guideline in the document 50. For example, “Line:(5,17)-(5,134)” indicates a guideline connecting the position 5 to the right and 17 down from the upper left corner of the document 50 with the position 5 to the right and 134 down from the upper left corner of the document 50.

The image data 66 may include, for example, identification information and the position in the document 50 for each image. For example, “Image:xx=(218,8,8,8)” indicates that the position, in the document 50, of the upper left corner of the image of which the identification information is “xx” is 218 to the right and 8 down from the upper left corner of the document 50 and that the size of the image is 8 in the left-right direction and 8 in the top-bottom direction.

After step S102, the hard copy generating unit 25a of the OCR system 20 instructs the MFP 30 to print the document to which the image codes have been added in step S102 via the communication unit 23 of the OCR system 20, as illustrated in FIG. 5 (step S103). When the control unit 38 of the MFP 30 receives the print instruction of the document from the OCR system 20 via the communication unit 36, the control unit 38 make the printer 33 print the document corresponding to the received instruction.

After step S103, the hard copy generating unit 25a ends the operation illustrated in FIG. 5.

In the above, the operator executes various instructions to the OCR system 20 via the operation unit 41 of the user terminal 40. In place of the operation unit 41 of the user terminal 40, the operator may execute various instructions to the OCR system 20 via the operation unit 31 of the MFP 30.

The operator distributes the hard copies printed through the operation illustrated in FIG. 5 to several people, for example, and asks these people who received the hard copies to handwrite appropriate characters in the handwriting input fields of the received hard copies. Each person who received the hard copy handwrites the appropriate characters in the handwriting input fields of the received hard copy, and then returns, to the operator, the hard copy with the appropriate characters handwritten in the handwriting input fields.

The operation of the OCR system 20 when information is extracted from a document image will now be explained.

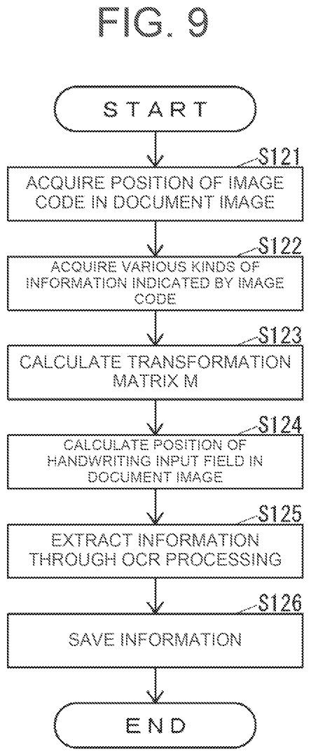

FIG. 9 is a flowchart illustrating an operation of the OCR system 20, when information is extracted from a document image.

The operator can place a hard copy that has been returned by a person who received a hard copy into the scanner 34 of the MFP 30, and instruct the MFP 30 to extract information from the hard copy, for example, via the operation unit 31 of the MFP 30. When the extraction of information from the hard copy is instructed, the control unit 38 of the MFP 30 reads, with the scanner 34, a document image from the hard copy placed in the scanner 34, and instructs the OCR system 20, via the communication unit 36 of the MFP 30, to extract information from the document image. Here, the instruction for extracting information from the document image (hereinafter referred to as “information extraction instruction”) includes the document image that is the target of this information extraction instruction. When the control unit 25 of the OCR system 20 receives the information extraction instruction via the communication unit 23, the control unit 25 executes the operation illustrated in FIG. 9.

As illustrated in FIG. 9, the image code position acquiring unit 25b acquires the position of an image code in the document image that is the target of the information extraction instruction (step S121).

After step S121, the data acquiring unit 25c acquires various kinds of information indicated by the image code contained in the document image that is the target of the information extraction instruction (step S122).

After step S122, the OCR target area position acquiring unit 25d calculates a transformation matrix M for the transformation of the hard copy to the document image that is the target of the information extraction instruction (step S123).

The method of calculating the transformation matrix M in step S123 will now be explained.

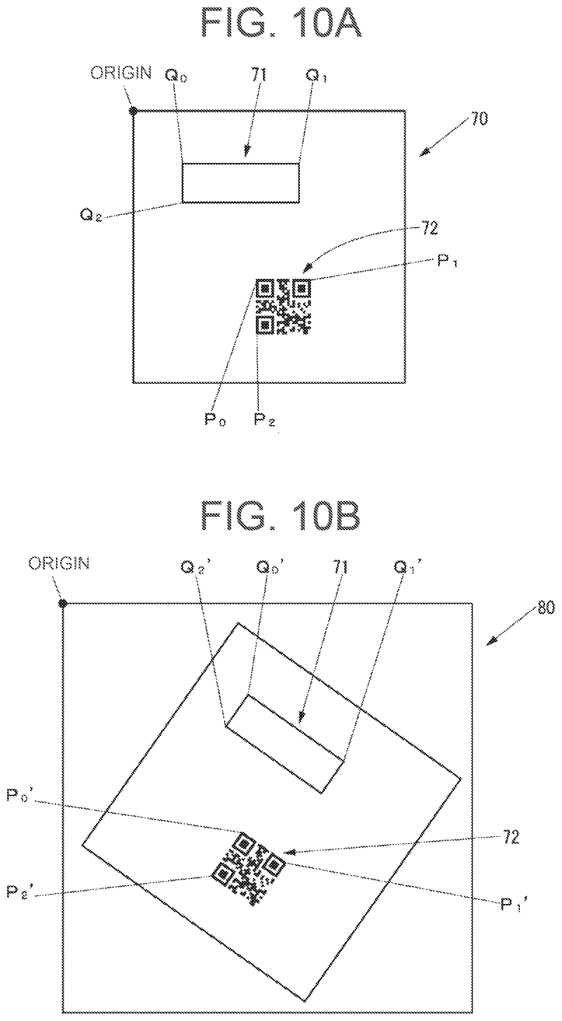

FIG. 10A is a diagram illustrating an example of a handwriting input field and an image code on a hard copy 70 that is a target of the operation illustrated in FIG. 9. FIG. 10B is a diagram illustrating an example of a handwriting input field and an image code in a document image read from the hard copy 70 illustrated in FIG. 10A.

In the hard copy 70 illustrated in FIG. 10A, the origin can be a point at any position for the subsequent calculations. However, for the purpose explanation, the origin is assumed to be at the upper left corner. The upper left corner, the upper right corner, and the lower left corner of a handwriting input field 71 in the hard copy 70 are respectively denoted by Q0, Q1, and Q2. The upper left corner, the upper right corner, and the lower left corner of an image code 72 in the hard copy 70 are respectively denoted by P0, P1, and P2.

In a document image 80 illustrated in FIG. 10B, the origin is assumed to be at the upper left corner. The upper left corner, the upper right corner, and the lower left corner of the handwriting input field 71 in the document image 80 are respectively denoted by Q0′, Q1′, and Q2′. The upper left corner, the upper right corner, and the lower left corner of the image code 72 in the document image 80 are respectively denoted by P0′, P1′, and P2′.

Assuming that the coordinate of P0 in the left-right direction is POx and the coordinate of P0 in the top-bottom direction is POy, the coordinates of P0 can be expressed as in Equations 1. Similarly, the coordinates of P1, P2, P0′, P1′ and P2′ can be expressed as in Equations 1. Note that the coordinates in Equations 1 are expressed in a homogeneous coordinate system used in affine transformation.

P₀=(P₀ₓ,P_{0y},1)=

P₁=(P₁ₓ,P_{1y},1)

P₂=(P₂ₓ,P_{2y},1)

P₀′=(P₀ₓ′,P_{0y}′,1)

P₁′=(P₁ₓ′,P_{1y}′,1)

P₂′=(P₂ₓ′,P_{2y}′,1) [Equations 1]

Assuming that the transformation from the handwriting input field 71 and the image code 72 in the hard copy 70 illustrated in FIG. 10A to the handwriting input field 71 and the image code 72, respectively, in the document image 80 illustrated in FIG. 10B is a transformation in which rotation, enlargement, and translation are combined, the transformation matrix M can be expressed as in Equation 2.

$$M = [ \begin{matrix}a & b & c \\ d & e & f \\ 0 & 0 & 1\end{matrix} ] \qquad [ Equation 2 ]$$

Here, the coordinates P0′, P1′, and P2′ can be expressed as in Equations 3 by using P0, P1, P2, and M.

P₀′=MP₀

P₁′=MP₁

P₂′=MP₂ [Equations 3]

Based on Equations 1 to 3, Equations 4 are established.

P₀ₓ′=aP₀ₓ+bP_{0y}+c
P_{0y}′=dP₀ₓ+eP_{0y}+f

P₁ₓ′=aP₁ₓ+bP_{1y}+c

P_{1y}′=dP₁ₓ+eP_{1y}+f

P₂ₓ′=aP₂ₓ+bP_{2y}+c

P_{2y′}=dP₂ₓ+eP_{2y}+f [Equations 4]

By combining Equations 4 by x and y, Equations 5 are obtained.

$$[ \begin{matrix}{P}_{0 x}^{′} \\ {P}_{1 x}^{′} \\ {P}_{2 x}^{′}\end{matrix} ] = [ \begin{matrix}{P}_{0 x} & {P}_{0 y} & 1 \\ {P}_{1 x} & {P}_{1 y} & 1 \\ {P}_{2 x} & {P}_{2 y} & 1\end{matrix} ] [ \begin{matrix}a \\ b \\ c\end{matrix} ] \\ [ \begin{matrix}{P}_{0 y}^{′} \\ {P}_{1 y}^{′} \\ {P}_{2 y}^{′}\end{matrix} ] = [ \begin{matrix}{P}_{0 x} & {P}_{0 y} & 1 \\ {P}_{1 x} & {P}_{1 y} & 1 \\ {P}_{2 x} & {P}_{2 y} & 1\end{matrix} ] [ \begin{matrix}d \\ e \\ f\end{matrix} ] \qquad [ Equations 5 ]$$

Based on Equations 5, Equation 6 is obtained.

$$[ \begin{matrix}{P}_{0 x}^{′} & {P}_{0 y}^{′} & 1 \\ {P}_{1 x}^{′} & {P}_{1 y}^{′} & 1 \\ {P}_{2 x}^{′} & {P}_{2 y}^{′} & 1\end{matrix} ] = [ \begin{matrix}{P}_{0 x} & {P}_{0 y} & 1 \\ {P}_{1 x} & {P}_{1 y} & 1 \\ {P}_{2 x} & {P}_{2 y} & 1\end{matrix} ] [ \begin{matrix}a & d & 0 \\ b & e & 0 \\ c & f & 1\end{matrix} ] \qquad [ Equation 6 ]$$

Based on Equation 6, Equation 7 is obtained. In Equation 7, −1 at the upper right corner of the matrix represents an inverse matrix. For Equation 7, a case where the inverse matrix does not exist is not considered.

$$[ \begin{matrix}a & d & 0 \\ b & e & 0 \\ c & f & 1\end{matrix} ] = {[ \begin{matrix}{P}_{0 x} & {P}_{0 y} & 1 \\ {P}_{1 x} & {P}_{1 y} & 1 \\ {P}_{2 x} & {P}_{2 y} & 1\end{matrix} ]}^{- 1} [ \begin{matrix}{P}_{0 x}^{′} & {P}_{0 y}^{′} & 1 \\ {P}_{1 x}^{′} & {P}_{1 y}^{′} & 1 \\ {P}_{2 x}^{′} & {P}_{2 y}^{′} & 1\end{matrix} ] \qquad [ Equation 7 ]$$

Based on Equations 2 and 7, the transformation matrix M can be expressed as Equation 8. In Equation 8, T at the upper right corner of the matrix represents a transposed matrix. In Equation 8, −1 at the upper right corner of the matrix represents an inverse matrix. For Equation 8, a case where the inverse matrix does not exist is not considered. Here, P0x, P0y, P1x, P1y, P2x, and P2y are indicated by the image code position data acquired in step S122. P0x′, P0y′, P1x′, P1y′, P2x′, and P2y′ are acquired in step S121.

$$M = [ \begin{matrix}a & b & c \\ d & e & f \\ 0 & 0 & 1\end{matrix} ] = {[ \begin{matrix}a & d & 0 \\ b & e & 0 \\ c & f & 1\end{matrix} ]}^{T} = {\{ {[ \begin{matrix}{P}_{0 x} & {P}_{0 y} & 1 \\ {P}_{1 x} & {P}_{1 y} & 1 \\ {P}_{2 x} & {P}_{2 y} & 1\end{matrix} ]}^{- 1} [ \begin{matrix}{P}_{0 x}^{′} & {P}_{0 y}^{′} & 1 \\ {P}_{1 x}^{′} & {P}_{1 y}^{′} & 1 \\ {P}_{2 x}^{′} & {P}_{2 y}^{′} & 1\end{matrix} ] \}}^{T} = {[ \begin{matrix}{P}_{0 x}^{′} & {P}_{1 x}^{′} & {P}_{2 x}^{′} \\ {P}_{0 y}^{′} & {P}_{1 y}^{′} & {P}_{2 y}^{′} \\ 1 & 1 & 1\end{matrix} ] [ \begin{matrix}{P}_{0 x} & {P}_{1 x} & {P}_{2 x} \\ {P}_{0 y} & {P}_{1 y} & {P}_{2 y} \\ 1 & 1 & 1\end{matrix} ]}^{- 1} \qquad [ Equation 8 ]$$

As illustrated in FIG. 9, after step S123, the OCR target area position acquiring unit 25d calculates the position of the handwriting input field in the document image that is the target of the information extraction instruction on the basis of the transformation matrix M calculated in step S123 and the position of the handwriting input field in the hard copy (step S124).

In other words, the positions Q0′, Q1′, and Q2′ of the handwriting input field in the document image that is the target of the information extraction instruction can be expressed as Equations 9 by using the transformation matrix M calculated in step S123 and positions Q0, Q1, and Q2 of the handwriting input field in the hard copy. Here, the coordinates of Q0, Q1, and Q2 are indicated by the handwriting input field data acquired in step S122.

Q₀′=MQ₀

Q₁′=MQ₁

Q₂′=MQ₂ [Equations 9]

As illustrated in FIG. 9, after step S124, the OCR processing unit 25e extracts information from the handwriting input field in the document image that is the target of the information extraction instruction through OCR processing based on the position calculated in step S124 (step S125). Here, the OCR processing unit 25e may use, in the OCR processing, the “type of characters to be used” indicated by the handwriting input field data acquired in step S122.

After step S125, the OCR processing unit 25e saves the information extracted in step S125 in the storage unit 24 (step S126). Here, the OCR processing unit 25e may store at least one piece of data acquired in step S122 together with the information extracted in step S125. For example, the OCR processing unit 25e can save the text data, the guideline data, and the image data acquired in step S122 together with the information extracted in step S125, to reproduce the hard copy based on the saved data. The OCR processing unit 25e may adopt a destination for the information in step S126 in accordance with the information indicated by the auto-indexing data acquired in step S122.

After step S126, the control unit 25 ends the operation illustrated in FIG. 9.

As explained above, the OCR system 20 acquires the position of the handwriting input field in the document image (steps S123 and S124) on the basis of the position of the image code in the document image, the position of an image code in a document included in image code position data indicated by the image code in the document image, and the position of a handwriting input field in the document in the handwriting input field data indicated by the image code in the document image. Thus, the OCR system 20 can specify a handwriting input field as an OCR target area in the document image with high precision, and, as a result can improve the accuracy of OCR processing. Thus, the OCR system 20 can streamline data entry operations, for example, for inputting information handwritten on a document into a computer as data.

Since the image code position data including the positions of the image codes in the document and the handwriting input field data including the positions of the handwriting input fields in the document are added to the hard copy 70 in the form of image codes, the OCR system 20 can specify the handwriting input fields in the document image with high precision. As a result, the OCR system 20 can increase the accuracy of the OCR processing.

The image code position data including the positions of the image codes in the document and the handwriting input field data including the positions of the handwriting input fields in the document are added to each hard copy in the form of image codes. Thus, even when information is continuously extracted from multiple document images generated from different types of hard copies, such as hard copies having different layouts, the OCR system 20 can specify the handwriting input fields in each document image with high precision.

Since the OCR system 20 generates a hard copy provided with image codes indicating the image code position data including the positions of the image codes in the document and the handwriting input field data including the positions of the handwriting input fields in the document (steps S101 to S103), a hard copy that can increase accuracy of the OCR processing can be generated.

In the above, the method of acquiring a document image by an MFP is described as a method of reading a document image from a hard copy by a scanner. However, the method of acquiring a document image by the MFP may be a method other than the method of reading a document image from a hard copy by a scanner. For example, the MFP may acquire a document image by receiving a document image through the fax communication unit.

In the above, an MFP is used as an example of an image reading apparatus. However, the image reading apparatus may be any apparatus other than an MFP with or without a scanner. The image reading apparatus may be, for example, a dedicated scanner. For example, the image reading apparatus may be an apparatus equipped with a camera that captures an image of a hard copy and generates a document image. The image reading apparatus may be, for example, a portable terminal. The document image generated from a hard copy by an apparatus including a camera is more likely to be shifted in position relative to an ideal document image when compared with a document image generated from a hard copy by an apparatus including a scanner. Thus, the disclosure is more likely to be needed when a document image is generated from a hard copy by an apparatus including a camera, as compared to when a document image is generated from a hard copy by an apparatus including a scanner.

In the above, the OCR system and the image reading apparatus are provided separately. However, for example, the OCR system may be built in to the image reading apparatus.

In the above, the OCR system and the user terminal are provided separately. However, for example, the OCR system may be built in to the user terminal.

In the above, the OCR system performs the OCR processing. However, the OCR system may request an external service, such as a cloud service, to perform the OCR processing.

The disclosure may be adopted, for example, by an enterprise implementing enterprise content management (ECM), robotic process automation (RPA), or the like.

What is claimed is:

1. An OCR target area position acquisition system comprising:
an image code position acquiring unit that acquires a position of an image code in a document image, the document image being an image of a document to which data is added by the image code;
a data acquiring unit that acquires the data indicated by the image code; and
an ORC target area position acquiring unit that acquires a position of an OCR target area in the document image, the OCR target area being an area, in the document image, to be subjected to OCR processing, wherein,
the data added to the document by the image code includes:
image code position data including a position of the image code in the document; and
OCR target area position data including a position of the OCR target area in the document, and
the ORC target area position acquiring unit acquires a position of the ORC target area in the document image based on:
a position of the image code in the document image, the image code being acquired by the image code position acquiring unit;
a position of the image code in the document, the image code being included in the image code position data acquired by the data acquiring unit; and
a position of the OCR target area in the document, the OCR target area being included in the OCR target area position data acquired by the data acquiring unit.

2. A computer-readable non-transitory storage medium storing an OCR target area position acquisition program that causes a computer to realize:
an image code position acquiring unit that acquires a position of an image code in a document image, the document image being an image of a document to which data is added by the image code;
a data acquiring unit that acquires the data indicated by the image code; and
an ORC target area position acquiring unit that acquires a position of an OCR target area in a document image, the OCR target area being an area, in the document image, to be subjected to OCR processing, wherein,
the data added to the document by the image code includes:
image code position data including a position of the image code in the document; and
OCR target area position data including a position of the OCR target area in the document, and
the ORC target area position acquiring unit acquires a position of the ORC target area in the document image based on:
a position of the image code in the document image, the image code being acquired by the image code position acquiring unit;
a position of the image code in the document, the image code being included in the image code position data acquired by the data acquiring unit; and
a position of the OCR target area in the document, the OCR target area being included in the OCR target area position data acquired by the data acquiring unit.

3. A hard copy that is an actual document to which data is added by an image code,
the data added to the document by the image code comprising:
image code position data including a position of the image code in the document; and
OCR target area position data including a position of an OCR target area in the document, the OCR target area being an area, in an image of the document, to be subjected to OCR processing.

4. A hard copy generation system comprising:
a hard copy generating unit that generates a hard copy, the hard copy being an actual document to which data is added by an image code, wherein
the data added to the document by the image code comprising:
image code position data including a position of the image code in the document; and
OCR target area position data including a position of an OCR target area in the document, the OCR target area being an area, in the image of the document, to be subjected to OCR processing.

5. A computer-readable non-transitory storage medium storing a hard copy generation program that causes a computer to realize:
a hard copy generating unit that generates a hard copy, the hard copy being an actual document to which data is added by an image code, wherein
the data added to the document by the image code comprising:
image code position data including a position of the image code in the document; and
OCR target area position data including a position of an OCR target area in the document, the OCR target area being an area, in the image of the document, to be subjected to OCR processing.
